(19) United States
(12) Patent Application Publication
(10) Pub. No.: US 2026/0254141 A1
(43) Pub. Date: Aug. 27, 2026

(54) CONNECTOR AND ELECTRONIC DEVICE

(71) Applicant: KYOCERA CORPORATION, Kyoto (JP)

(72) Inventors: Fumihito IKEGAMI, Funabashi-shi, Chiba (JP); Nobuyuki NAKAJIMA, Taito-ku, Tokyo (JP)

(21) Appl. No.: 18/863,987

(22) PCT Filed: May 8, 2023
(86) PCT No.: PCT/JP2023/017339

§ 371 Date: Nov. 7, 2024

(30) Foreign Application Priority Data
May 17, 2022 (JP) 2022-081177

(51) Int. Cl. H01R 12/77; H01R 12/79

(52) U.S. Cl. CPC H01R 12/775; H01R 12/79

(57) ABSTRACT

In the present disclosure, a connector 10 includes: an insulator 20 including an insertion portion 23 into which a connection object 70 is inserted; multiple contacts 30 attached to the insulator 20, each contact 30 including a mount portion configured to be mounted on a circuit board CB; a first metal member 50 attached to the insulator 20; and a second metal member 60 attached to at least one of the insulator 20 or the first metal member 50, in which the first metal member 50 includes an opening 52 that enables the mount portions to be seen from an outer surface of the first metal member 50 in a non-inserted state in which the connection object 70 is not inserted into the insertion portion 23, and the second metal member 60 includes a shield portion 61 configured to move along with insertion of the connection object 70 into the insertion portion 23 and to overlap the opening 52 in an inserted state in which the connection object 70 is inserted into the insertion portion 23.

### CROSS-REFERENCE TO RELATED APPLICATIONS

The present application claims priority from Japanese Patent Application No. 2022-081177 (filed May 17, 2022) the disclosure of which is hereby incorporated by reference herein in its entirety.

### TECHNICAL FIELD

The present disclosure relates to a connector and an electronic device.

BACKGROUND OF INVENTION

A technique related to a connector used in communication devices and the like and configured to be connected to a connection object such as a flexible printed circuit board (FPC), a flexible flat cable (FFC), or the like is known.

For example, Patent Literature 1 discloses a connector that is capable of shielding electromagnetic wave noises and also enables the connection states between the contacts and the wiring board to be checked easily. This connector includes an opening in a conductive shell for checking, with an inspection camera, whether the connector is mounted properly on a wiring board, in other words, a circuit board. This connector includes a cover member that can be opened and closed relative to the shell, for effectively shielding electromagnetic wave noises. Opening/closing the cover member enables switching between exposing and shielding the opening.

### CITATION LIST

### Patent Literature

Patent Literature 1: Japanese Unexamined Patent Application Publication No. 2021-039830

### SUMMARY

In an embodiment of the present disclosure, a connector includes:
an insulator including an insertion portion into which a connection object is inserted;
multiple contacts attached to the insulator, each contact including a mount portion configured to be mounted on a circuit board;
a first metal member attached to the insulator; and
a second metal member attached to at least one of the insulator or the first metal member.

The first metal member includes an opening that enables the mount portions to be seen from an outer surface of the first metal member in a non-inserted state in which the connection object is not inserted into the insertion portion.

The second metal member includes a shield portion configured to move along with insertion of the connection object into the insertion portion and to overlap the opening in an inserted state in which the connection object is inserted into the insertion portion.

In an embodiment of the present disclosure, an electronic device includes the connector described above.

### BRIEF DESCRIPTION OF THE DRAWINGS

FIG. 1 is a perspective view of a connector according to an embodiment and a connection object in a non-inserted state, illustrating the outer appearance from above.

FIG. 2 is a perspective view of the connector according to an embodiment and the connection object in an inserted state, illustrating the outer appearance from above.

FIG. 3 is a perspective view of the connector and the connection object in FIG. 1, illustrating the outer appearance from below.

FIG. 4 is an exploded perspective view of the connector in FIG. 1 alone.

FIG. 5 is a bottom view of a first metal member alone.

FIG. 6 is a top view of the connector and the connection object in FIG. 1.

FIG. 7 is a top view of the connector and the connection object in FIG. 2.

FIG. 8 is an enlarged top view of the dashed-dotted-line rectangular portion VIII in FIG. 6.

FIG. 9 is an enlarged top view of the dashed-dotted-line rectangular portion IX in FIG. 7.

FIG. 10 is a cross-sectional view taken along arrow line X-X in FIG. 7.

FIG. 11 is a cross-sectional view taken along arrow line XI-XI in FIG. 7.

FIG. 12 is a cross-sectional view taken along arrow line XII-XII in FIG. 7.

FIG. 13 is a cross-sectional view taken along arrow line XIII-XIII in FIG. 6.

FIG. 14 is a cross-sectional view taken along arrow line XIV-XIV in FIG. 7.

### DESCRIPTION OF EMBODIMENTS

Along with trends toward higher speed and wider bandwidth in communication using communication devices in recent years, higher noise shielding effects against electromagnetic wave noises are required.

For example, in the connector disclosed in Patent Literature 1, a rotatable conductive cover member is operated relative to a conductive shell. This configuration of the connector enables the connection states between the circuit board and the contacts to be inspected through an opening in an open state of the cover member and also enables the noise shielding effect to be improved by covering the opening with the cover member in a closed state.

The connector and the electronic device according an embodiment of the present disclosure improves the workability and the noise shielding effect.

Hereinafter, an embodiment of the present disclosure will be described in detail with reference to the accompanying drawings. In the following description, the front-rear direction, the right-left direction, and the up-down direction are based on the arrow directions in the figures. The direction of each arrow is consistent across the different drawings. In some drawings, illustration of a circuit board CB described later is omitted to make illustration simple.

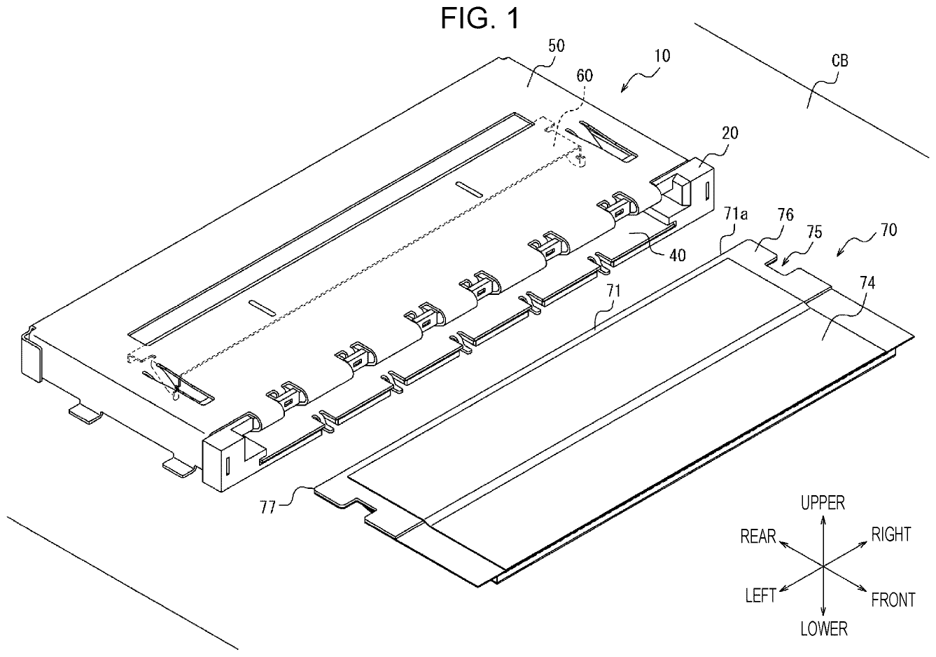

The configuration of a connector 10 according to an embodiment and the configuration of a connection object 70 are mainly described with reference to FIGS. 1 to 5.

FIG. 1 is a perspective view of the connector 10 according to an embodiment and the connection object 70 in a non-inserted state, illustrating the outer appearance from above.

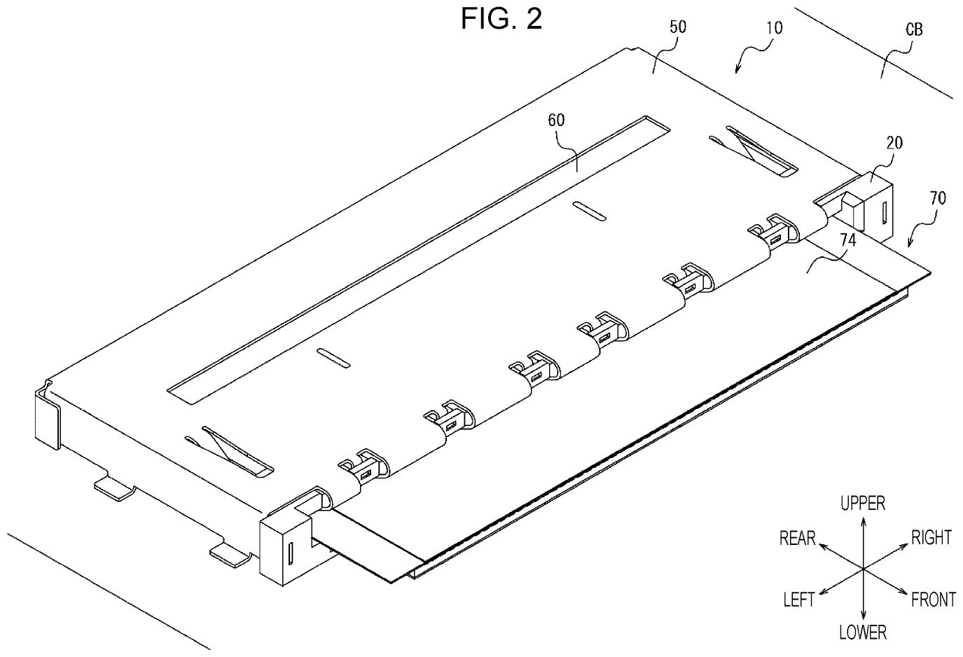

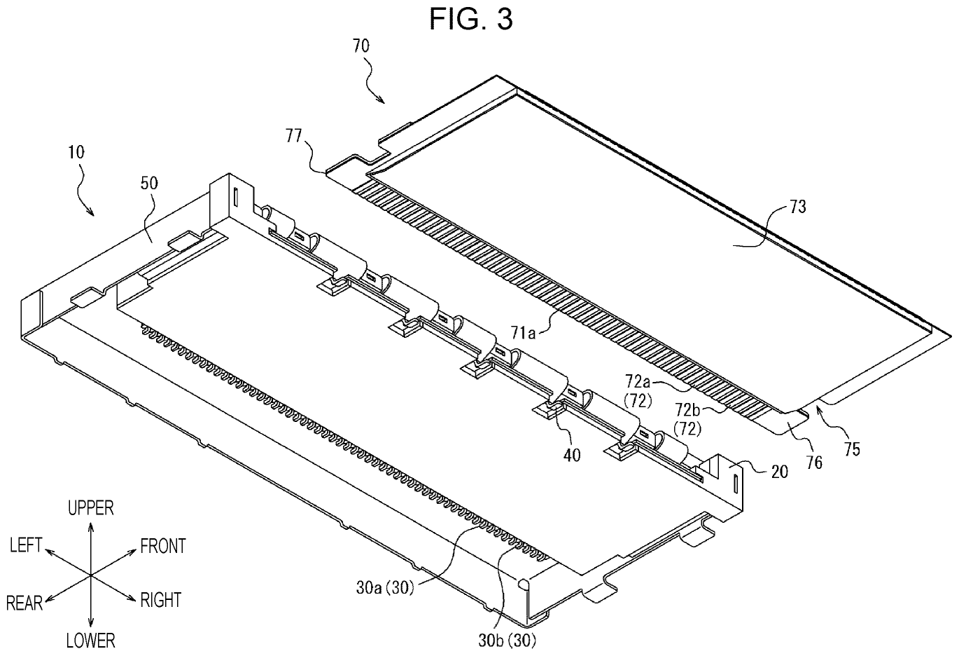

FIG. 2 is a perspective view of the connector 10 according to an embodiment and the connection object 70 in an inserted state, illustrating the outer appearance from above. FIG. 3 is a perspective view of the connector 10 and the connection object 70 in FIG. 1, illustrating the outer appearance from below.

The connector 10 includes an insulator 20, contacts 30 including first contacts 30a and second contacts 30b, a third metal member 40, a first metal member 50, and a second metal member 60. The first contacts 30a, the second contacts 30b, the third metal member 40, the first metal member 50, and the second metal member 60 are attached to the insulator 20.

In this specification, “the non-inserted state” denotes, for example, a state in which a connection object 70 is not inserted into the connector 10, which includes a state in which the first contacts 30a and the second contacts 30b of the connector 10 are not elastically deformed. “The inserted state” denotes, for example, a state in which a connection object 70 is inserted into the connector 10, which includes a state in which the first contacts 30a and the second contacts 30b are in contact with the connection object 70 and are elastically deformed. In the following, a non-inserted state in which a connection object 70 has never been inserted into an insertion portion 23 is defined as a first state, the inserted state is defined as a second state, and a non-inserted state in which the connection object 70 is pulled out in the second state is defined as a third state.

“An insertion-pull-out direction of the connection object 70” used below refers to the front-rear direction as an example. “An insertion direction of the connection object 70” refers to the rearward direction as an example. “A pull-out direction of the connection object 70” refers to the frontward direction as an example. “An arrangement direction of the multiple contacts 30” refers to the right-left direction as an example. “A pull-out side” refers to the front side as an example. “An insertion side” refers to the rear side as an example. “The circuit board CB side” refers to the lower side as an example. “The side opposite to the circuit board CB” refers to the upper side as an example.

In an embodiment, the connector 10 is mounted on the circuit board CB. The circuit board CB may be a rigid board or another kind of circuit board other than rigid boards, including a flexible printed circuit board (FPC). The connector 10 electrically connects the connection object 70 inserted into the connector 10 to the circuit board CB with the first contacts 30a and the second contacts 30b interposed therebetween. The connection object 70 can be inserted into and pulled out of the connector 10, and the connector 10 is connected to the connection object 70 in the inserted state.

The following description is based on the assumption that the connection object 70 is inserted into the connector 10, parallel to the circuit board CB on which the connector 10 is mounted. The connection object 70 is inserted into the connector 10 in the front-rear direction as an example. However, the present disclosure is not limited to this configuration. The connection object 70 may be inserted into the connector 10 in the direction orthogonal to the circuit board CB on which the connector 10 is mounted. The connection object 70 may be inserted into the connector 10 in the up-down direction.

The connection object 70 is a flexible flat cable (FFC) as an example. However, the present disclosure is not limited to this configuration. The connection object 70 may be any cable that is electrically connected to the circuit board CB with the connector 10 interposed therebetween. For example, the connection object 70 may be an FPC. The connection object 70 is not limited to the cables as mentioned above and may be any connection object. Examples of the connection object 70 may include a rigid board or any other circuit board.

As illustrated in FIGS. 1 and 3, the connection object 70 has a lamination structure in which multiple thin film materials are attached to one another with an adhesive. The connection object 70 includes an reinforcement portion 71. The reinforcement portion 71 is a distal end portion in the extending direction of the connection object 70, in other words, the insertion-pull-out direction in which the connection object 70 is inserted and pulled out, and is harder than the other portions. The reinforcement portion 71 is located on the insertion side of the connection object 70 and is configured to be stored in the connector 10 in the inserted state. The connection object 70 includes a distal end surface 71a which is the end surface of the reinforcement portion 71 on the insertion side of the connection object 70. The connection object 70 includes multiple connection lines 72 extending linearly in the insertion-pull-out direction to the distal end of the reinforcement portion 71. The connection lines 72 are exposed on the lower side at the distal end of the connection object 70. The connection lines 72 include first connection lines 72a configured to be in contact with the first contacts 30a in the inserted state and second connection lines 72b configured to be in contact with the third metal member 40 in the inserted state.

The connection object 70 includes a first ground portion 73 which is the lower outermost layer covering part of the connection lines 72 on the pull-out side of the connection object 70. The first ground portion 73 extends from front toward rear in a flat plate shape and is bent obliquely upward at the distal end. The connection object 70 includes a second ground portion 74 which is the upper outermost layer covering approximately the entire part of the connection lines 72. The second ground portion 74 extends from front toward rear in a flat plate shape and is bent obliquely upward in the front edge portion of the reinforcement portion 71, and the distal end portion of the second ground portion 74 is stacked on the reinforcement portion 71.

The connection object 70 includes lock receiving portions 75 located on both right and left edge portions of the distal end portion including the reinforcement portion 71 and having such shapes that center portions of the right and left edge portions are cut inward in the right-left direction. The lock receiving portions 75 are formed on both right and left sides of the distal end portion of the connection object 70 including the reinforcement portion 71. The connection object 70 includes hold portions 76 formed in both right and left side portions of the distal end portion on the insertion side. The hold portions 76 adjoin the insertion sides of the lock receiving portions 75. The connection object 70 includes introduction portions 77 located at corner portions of the insertion sides of the hold portions 76 and having rounded shapes.

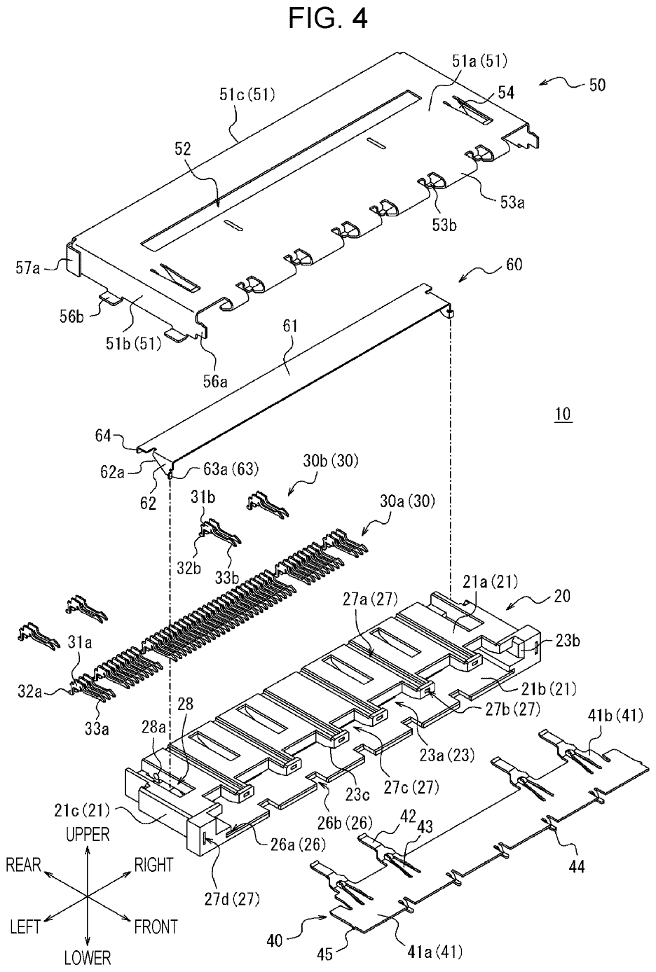

FIG. 4 is an exploded perspective view of the connector 10 in FIG. 1 alone.

The connector 10 is assembled by the following method as an example. From the rear side of the insulator 20, the first contacts 30a and the second contacts 30b are press-fitted into the insulator 20. From the front side of the insulator 20, the third metal member 40 is press-fitted into the insulator 20. From the upper side of the insulator 20, the second metal member 60 is attached to the insulator 20. In this state, the second metal member 60 is attached to the insulator 20 so as to be slidable in the insertion direction of the connection object 70. In the state in which the second metal member 60 is attached to the insulator 20, the first metal member 50 is placed from above the insulator 20 and the second metal member 60 and slid from rear toward front to be press-fitted into the insulator 20.

The configuration of the insulator 20 will be mainly described.

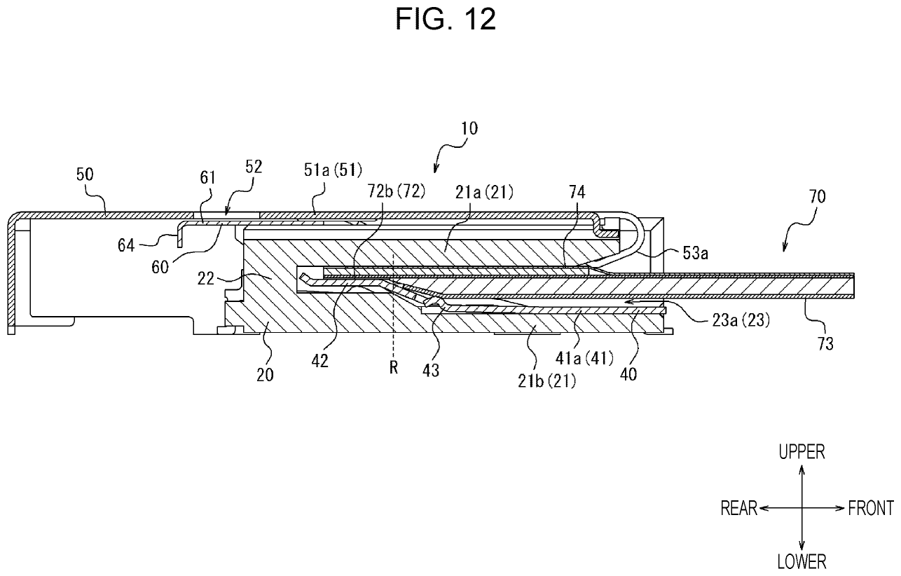

The insulator 20 is a box-shaped member symmetrical in the right-left direction, formed by injection-molding an insulating and heat-resistant plastic material. However, the present disclosure is not limited to this configuration. The insulator 20 may be formed to be asymmetrical in the right-left direction. The insulator 20 includes four outer walls on the upper, lower, right, and left sides and includes an outer peripheral wall 21 formed in a rectangular parallelepiped as a whole. The outer peripheral wall 21 includes a ceiling wall 21a, a bottom wall 21b, and a pair of side walls 21c. For example, as illustrated in FIG. 12 described later, the insulator 20 includes a rear wall 22 connecting rear end portions of the ceiling wall 21a and the bottom wall 21b of the insulator 20 in the up-down direction.

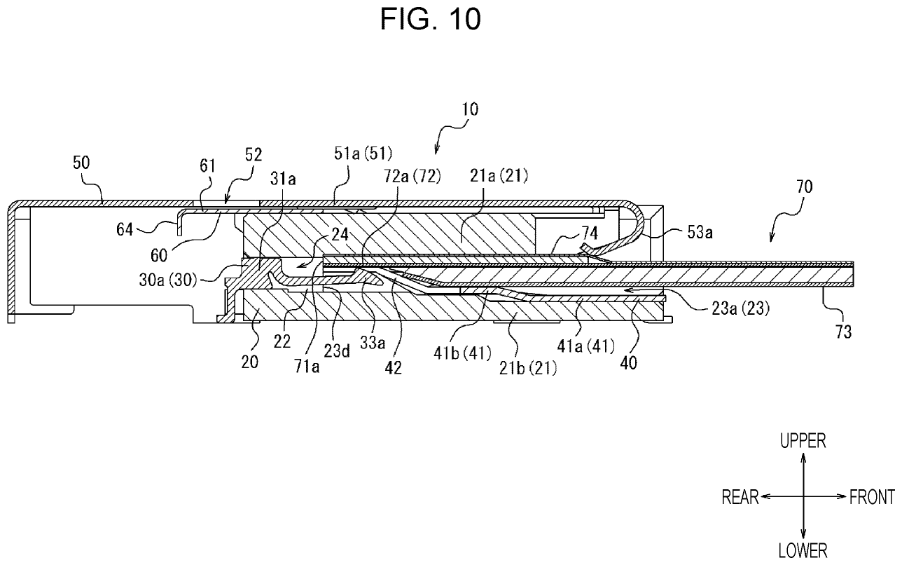

As illustrated in FIG. 4, the insulator 20 includes the insertion portion 23 surrounded by the ceiling wall 21a, the bottom wall 21b, the pair of side walls 21c, and the rear wall 22. The insulator 20 includes the insertion opening 23a of the insertion portion 23 which is an opening at the front end portion. The insulator 20 includes first inclined surfaces 23b located in front end portions of the side walls 21c and inclined inward in the right-left direction from the outer side toward the inner side in the front-rear direction and connected to the insertion portion 23. The insulator 20 includes second inclined surfaces 23c formed in front end portions of the insertion portion 23 and inclined inward in the up-down direction from the outer side toward the inner side in the front-rear direction. For example, as illustrated in FIG. 10 described later, the insertion portion 23 includes an inner surface 23d that serves as a reference for positioning the distal end surface 71a of the connection object 70 in the insertion direction in the inserted state.

For example, as illustrated in FIG. 10 described later, the insulator 20 includes multiple first-contact attachment slits 24 passing through the rear wall 22 and extending inside the insertion portion 23. The multiple first-contact attachment slits 24 are away from one another with specified distances in between in the right-left direction. The multiple first-contact attachment slits 24 are formed to correspond to the arrangement of the first contacts 30a in the right-left direction.

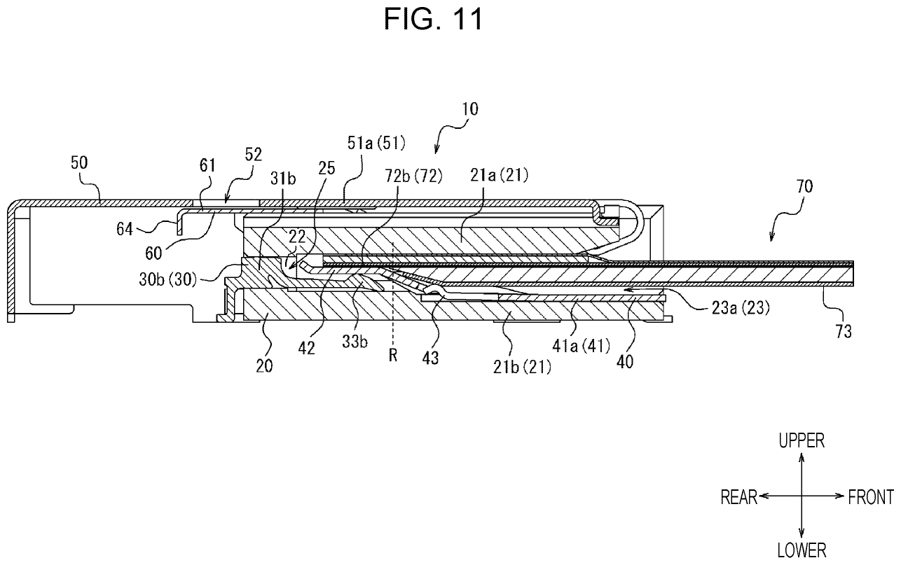

For example, as illustrated in FIG. 11 described later, the insulator 20 includes multiple second-contact attachment slits 25 passing through the rear wall 22 and extending inside the insertion portion 23. The multiple second-contact attachment slits 25 are away from one another with specified distances in between in the right-left direction. The multiple second-contact attachment slits 25 are formed to correspond to the arrangement of the second contacts 30b in the right-left direction.

As illustrated in FIG. 4, the insulator 20 includes a metal-member attachment portion 26 formed in the bottom wall 21b. The metal-member attachment portion 26 includes metal-member attachment slits 26a which are recesses located in both right and left end portions of the bottom wall 21b. The metal-member attachment portion 26 includes multiple first cut-out portions 26b formed in the front edge portions of the bottom wall 21b. The multiple first cut-out portions 26b have such shapes that front edge portions of the bottom wall 21b are cut out at approximately uniform intervals in the arrangement direction of the multiple contacts 30.

The insulator 20 includes an attachment portion 27 extending over the ceiling wall 21a and the side walls 21c. The attachment portion 27 includes multiple slits 27a extending linearly in the front-rear direction in the ceiling wall 21a. The multiple slits 27a are recesses in the ceiling wall 21a spaced at specified intervals in the arrangement direction of the multiple contacts 30. The attachment portion 27 includes first through holes 27b extending through front end portions of the ceiling wall 21a in the front-rear direction and connected to the slits 27a.

The attachment portion 27 includes multiple second cut-out portions 27c formed in front edge portions of the ceiling wall 21a. The multiple second cut-out portions 27c have such shapes that front edge portions of the ceiling wall 21a are cut out so as to be spaced at specified intervals in the arrangement direction of the multiple contacts 30. The second cut-out portion 27c is located between one set of a slit 27a and a first through hole 27b and another adjacent set in the right-left direction. The attachment portion 27 includes second through holes 27d located at front end portions of the side walls 21c and extending through the side walls 21c in the front-rear direction.

The insulator 20 includes attachment slits 28 which are recesses located at both right and left end portions of the ceiling wall 21a and extending in the front-rear direction. The attachment slits 28 extend from the rear wall 22 to approximately center portions of the ceiling wall 21a in the front-rear direction. Each attachment slit 28 passes where part of the rear wall 22 is cut out from above and extends through part of the ceiling wall 21a from the upper surface to the inside of the insertion portion 23. The insulator 20 includes restriction portions 28a protruding on the inner side surfaces of the attachment slits 28 in the right-left direction. The restriction portions 28a are circular protrusions formed on the side surfaces of the attachment slits 28.

The configuration of the first contact 30a will be mainly described.

The first contact 30a is formed, for example, by forming a thin plate composed of a copper alloy having a spring elasticity such as phosphor bronze, beryllium copper, or titanium copper, or a Corson copper alloy into the shape illustrated in FIG. 4 by using a progressive die (stamping). The first contact 30a is formed, for example, by only punching. The forming method of the first contact 30a is not limited to this one and may include, for example, bending in the thickness direction after punching. The surface of the first contact 30a is undercoated with nickel plating and then surface-plated with gold, tin, or the like. The multiple first contacts 30a are away from one another with specified distances in between in the right-left direction, corresponding to the multiple first-contact attachment slits 24.

The first contact 30a includes an engagement portion 31a having wide widths in the front-rear and up-down directions. The first contact 30a includes a mount portion 32a extending downward from a rear end portion of the engagement portion 31a. The first contact 30a includes an elastic contact portion 33a extending forward from a front end portion of the engagement portion 31a and elastically deformable in the up-down direction. The elastic contact portion 33a extends downward from the front end portion of the engagement portion 31a, is then curved, and extends forward linearly, sloping obliquely upward.

The configuration of the second contact 30b will be mainly described.

The second contact 30b is formed, for example, by forming a thin plate composed of a copper alloy having a spring elasticity such as phosphor bronze, beryllium copper, or titanium copper, or a Corson copper alloy into the shape illustrated in FIG. 4 by using a progressive die (stamping). The second contact 30b is formed, for example, by only punching. The forming method of the second contact 30b is not limited to this one and may include, for example, bending in the thickness direction after punching. The surface of the second contact 30b is undercoated with nickel plating and then surface-plated with gold, tin, or the like. The multiple second contacts 30b are away from one another with specified distances in between in the right-left direction, corresponding to the multiple second-contact attachment slits 25.

The second contact 30b includes an engagement portion 31b having wide widths in the front-rear and up-down directions. The second contact 30b includes a mount portion 32b extending downward from a rear end portion of the engagement portion 31b. The second contact 30b includes an elastic contact portion 33b extending forward from a front end portion of the engagement portion 31b and elastically deformable in the up-down direction. The elastic contact portion 33b extends downward from the front end portion of the engagement portion 31b, is then curved, and extends forward linearly, sloping slightly obliquely upward. The obliquely upward slope of the elastic contact portion 33b is gentler than the obliquely upward slope of the elastic contact portion 33a. The elastic contact portion 33b slopes slightly obliquely upward being closer to a level than the elastic contact portion 33a.

The configuration of the third metal member 40 will be mainly described.

The third metal member 40 is formed by forming a thin plate composed of any metal material into the shape illustrated in FIG. 4 by using a progressive die (stamping). The third metal member 40 is formed by punching and then bending in the thickness direction. The forming method of the third metal member 40 is not limited to this one and may include, for example, only punching. The surface of the third metal member 40 is undercoated with nickel plating and then surface-plated with gold, tin, or the like. Plating including nickel plating and surface plating may be applied only to portions where plating is necessary.

The third metal member 40 includes a base portion 41 having a plate shape extending in the front-rear and right-left directions. The base portion 41 includes a first portion 41a having a flat plate shape extending in the front-rear and right-left directions and a second portion 41b bent obliquely upward at a rear edge portion of the first portion 41a and then extending levelly again.

The third metal member 40 includes first contact portions 42 extending rearward from the base portion 41, for example, from rear edge portions of the second portion 41b.

Each first contact portion 42 extends rearward levelly from a rear edge portion of the second portion 41b and is bent obliquely upward, and then a rear portion of the first contact portion 42 extends levelly again. A rear end portion of the first contact portion 42 slopes obliquely sharply upward from a levelly extending portion. The first contact portion 42 has a wide width in the right-left direction from the portion connected to the second portion 41b to a center portion of the portion bent and extending obliquely upward and is tapered from this center portion toward the rear portion of the first contact portion 42. The first contact portion 42 includes a portion cut out in the thickness direction in a center portion in the right-left direction of the portion having a wide width in the right-left direction. The first contact portions 42 are elastically deformable in the up-down direction.

The third metal member 40 includes second contact portions 43 located forward of the first contact portions 42 and extending rearward from the base portion 41, for example, from rear portions of the first portion 41a. Each second contact portion 43 linearly extends obliquely upward from a rear portion of the first portion 41a, and a rear end portion of the second contact portion 43 is bent upward. The second contact portion 43 is tapered such that the width in the right-left direction is continuously reduced from the portion connected to the first portion 41a to the rear end portion. The entire second contact portion 43 is located within the second portion 41b and the portion of the first contact portion 42 cut out in the thickness direction. The rear end portion of the second contact portion 43 is located in the portion of the first contact portion 42 cut out in the thickness direction. The second contact portions 43 are elastically deformable in the up-down direction.

The third metal member 40 includes total four sets of a first contact portion 42 and a second contact portion 43, two sets on the left side and two sets on the right side. The sets of a first contact portion 42 and a second contact portion 43 are away from one another in the right-left direction. A first contact portion 42 and a second contact portion 43 are located in the same straight line in the front-rear direction.

The third metal member 40 includes multiple mount portions 44 bent at front end portions of the first portion 41a of the base portion 41, extending obliquely downward, then bent again, and extending forward levelly. The multiple mount portions 44 are located at front end portions of the first portion 41a of the base portion 41, being spaced approximately at the same interval in the arrangement direction of the multiple contacts 30. The third metal member 40 includes engagement portions 45 formed at both right and left end portions of the first portion 41a of the base portion 41.

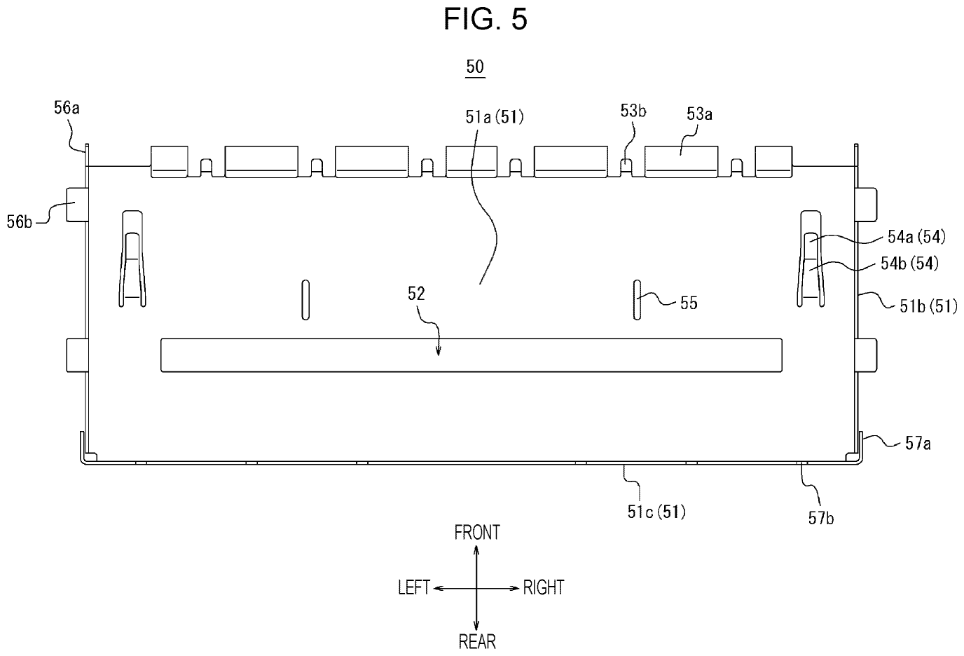

FIG. 5 is a bottom view of the first metal member 50 alone. The configuration of the first metal member 50 will be mainly described with reference to FIGS. 4 and 5.

The first metal member 50 is formed by forming a thin plate composed of any metal material into the shape illustrated in FIGS. 4 and 5 by using a progressive die (stamping). The first metal member 50 is formed by punching and then bending in the thickness direction. The forming method of the first metal member 50 is not limited to this one and may include, for example, only punching.

The first metal member 50 includes an outer peripheral portion 51 including the outer periphery on the front, the right and left, and the rear sides. The outer peripheral portion 51 includes a ceiling portion 51a, a pair of side portions 51b, and a rear portion 51c. The first metal member 50 includes an opening 52 extending through the ceiling portion 51a. The opening 52 is located in a rear portion of the ceiling portion 51a and has a shape wide in the right-left direction and narrow in the front-rear direction. The opening 52, located in a rear portion of the ceiling portion 51a, extends approximately over the entire part of the ceiling portion 51a in the right-left direction.

The first metal member 50 includes multiple contact portions 53a formed at front edge portions of the ceiling portion 51a. The contact portions 53a are bent at front edge portions of the ceiling portion 51a in a U shape, extend obliquely downward toward the rear, and then rise a little sharply upward in end portions. The contact portions 53a are elastically deformable in the up-down direction. The multiple contact portions 53a are formed at the front edge portions of the ceiling portion 51a, being spaced at specified intervals in the arrangement direction of the multiple contacts 30.

The first metal member 50 includes multiple hold portions 53b formed at front edge portions of the ceiling portion 51a. Each hold portion 53b is bent in a crank shape at a front edge portion of the ceiling portion 51a and extends forward. The multiple hold portions 53b are formed at the front edge portions of the ceiling portion 51a, being spaced at specified intervals in the arrangement direction of the multiple contacts 30. Each hold portion 53b is located between one contact portion 53a and another adjacent contact portion 53a in the right-left direction. In the front edge portion of the ceiling portion 51a, the contact portions 53a and the hold portions 53b are alternately located in the right-left direction.

The first metal member 50 includes lock portions 54 extending obliquely downward toward the front from both right and left end portions of an approximately center portion in the front-rear direction in the ceiling portion 51a. The lock portions 54 are elastically deformable in the up-down direction. Each lock portion 54 linearly extends obliquely downward toward the front from the ceiling portion 51a, and the front end portion of the lock portion 54 is bent in an arc shape and then slopes obliquely upward. The lock portion 54 includes a first contact portion 54a which is a portion sloping obliquely upward at the front end portion. The lock portion 54 includes a second contact portion 54b which is a portion included in the arc-shaped bent portion in the front end portion and located on the side opposite to the first contact portion 54a in the front-rear direction.

The first metal member 50 includes a pair of protrusions 55 located on both right and left sides of an approximately center portion of the ceiling portion 51a in the front-rear direction. The protrusions 55 are located on the inner surface of the ceiling portion 51a on the circuit board CB side and each have a straight line shape parallel to the insertion direction of the connection object 70. The protrusions 55 protrude downward from the inner surface of the ceiling portion 51a. The outer surface of the ceiling portion 51a has recesses at the positions where the protrusions 55 are formed.

The first metal member 50 includes engagement portions 56a protruding forward from front edge portions of the side portions 51b. The first metal member 50 includes a pair of first mount portions 56b bent at lower edge portions of the side portions 51b and extending outward in the right-left direction.

The first metal member 50 has folded portions 57a folded in L shapes at both right and left end portions of the rear portion 51c. The portions of the folded portions 57a extending in the front-rear direction are parallel to the side portions 51b extending in the front-rear direction. The portions of the folded portions 57a extending in the front-rear direction are adjacent to the right and left outer sides of rear end portions of the side portions 51b. The portions of the folded portions 57a extending in the front-rear direction overlap the right and left sides of approximately the entire parts in the up-down direction of rear end portions of the side portions 51b. Hence, each corner portion on the rear side of the first metal member 50 has a two-layer structure in the right-left direction including the portion of the folded portion 57a extending in the front-rear direction and a rear end portion of the side portion 51b. The first metal member 50 includes multiple second mount portions 57b extending linearly downward from lower edge portions of the rear portion 51c.

With reference to FIG. 4 again, the configuration of the second metal member 60 will be mainly described.

The second metal member 60 is formed by forming a thin plate composed of any metal material into the shape illustrated in FIG. 4 by using a progressive die (stamping). The second metal member 60 is formed by punching and then bending in the thickness direction. The forming method of the second metal member 60 is not limited to this one and may include, for example, only punching.

The second metal member 60 includes a shield portion 61 having a rectangular shape extending in the front-rear and right-left directions. The second metal member 60 includes restriction receiving portions 62 formed so as to be folded downward at both right and left end portions of the shield portion 61. The restriction receiving portions 62 are formed over the entire front halves of both right and left edge portions of the shield portion 61. Each restriction receiving portion 62 includes a slope portion 62a linearly sloping obliquely downward from rear toward front. The second metal member 60 includes contact portions 63 located at lower end portions of the restriction receiving portions 62 and bent outward in the right-left direction in L shapes. Each contact portion 63 includes a contact surface 63a facing the pull-out side. The second metal member 60 includes a folded back portion 64 extending downward from the entire rear edge portion of the shield portion 61.

As illustrated in FIGS. 1 and 2, the connector 10 is mounted onto the circuit board CB in the state in which the first contacts 30a, the second contacts 30b, the third metal member 40, the first metal member 50, and the second metal member 60 are attached to the insulator 20. More specifically, the connector 10 is mounted on a circuit formation surface formed on the upper surface of the circuit board CB placed approximately parallel to the insertion-pull-out direction.

The mount portions 32a of the first contacts 30a are placed on solder paste applied to pads on the circuit board CB. The mount portions 32b of the second contacts 30b are placed on solder paste applied to pads on the circuit board CB. The mount portions 44 of the third metal member 40 are placed on solder paste applied to pads on the circuit board CB. The first mount portions 56b and the second mount portions 57b of the first metal member 50 are placed on solder paste applied to pads on the circuit board CB.

The solder paste is heated and melted in a reflow oven or the like, so that the mount portions 32a, the mount portions 32b, the mount portions 44, the first mount portions 56b, and the second mount portions 57b are soldered to the pads mentioned above. With this process, the connector 10 is completely mounted onto the circuit board CB. In addition to the connector 10, for example, other electronic components including a central processing unit (CPU), a controller, and memory are also mounted onto the circuit formation surface of the circuit board CB.

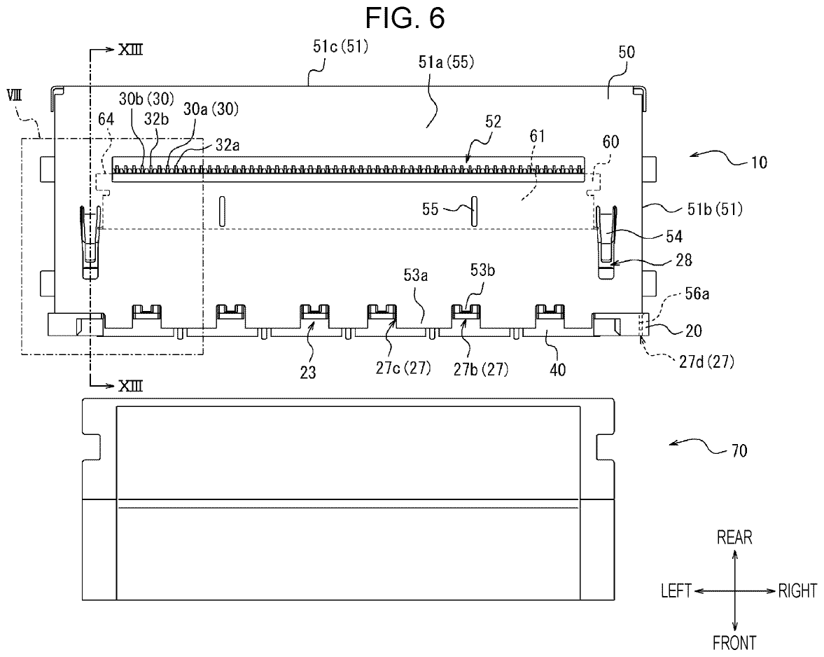

In the following, the functions of the connector 10 will be mainly described with reference to FIGS. 6 to 14.

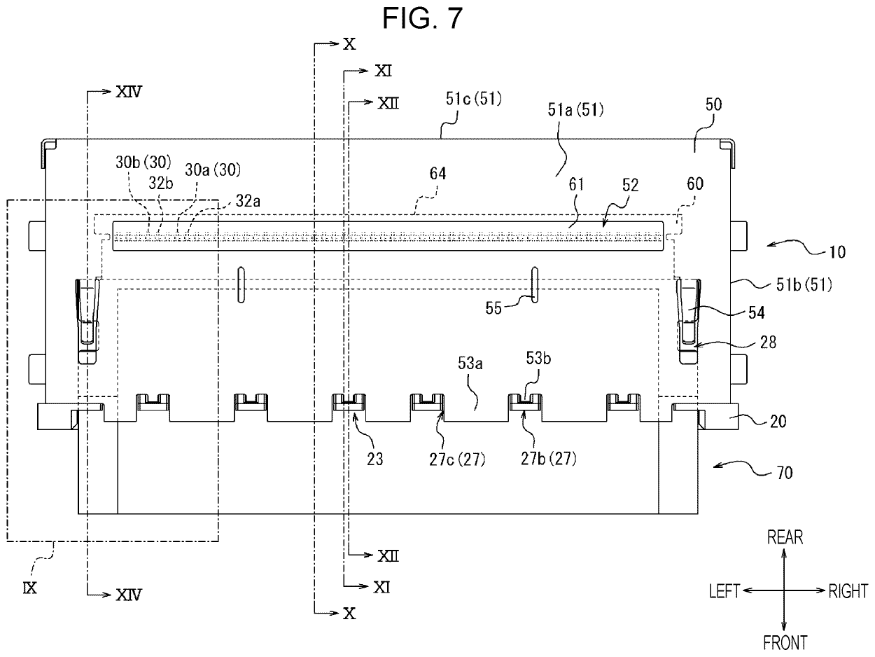

FIG. 6 is a top view of the connector 10 and the connection object 70 in FIG. 1. FIG. 7 is a top view of the connector 10 and the connection object 70 in FIG. 2.

The first metal member 50 is attached to the insulator 20 so as to cover all the components included in the connector 10 from the upper, right and left, and rear outer sides. The hold portions 53b are slid from rear toward front along the slits 27a in the attachment portion 27 of the insulator 20 and held by the first through holes 27b of the attachment portion 27. The engagement portions 56a are inserted into the second through holes 27d of the attachment portion 27 of the insulator 20 from rear toward front and are engaged with the second through holes 27d.

When the first metal member 50 is attached to the insulator 20, the contact portions 53a are located in the second cut-out portions 27c of the insulator 20. The ceiling portion 51a covers the insulator 20 from the side opposite to the circuit board CB. The ceiling portion 51a covers the shield portion 61 and the ceiling wall 21a from the upper side with the shield portion 61 of the second metal member 60 located between the ceiling portion 51a and the ceiling wall 21a of the insulator 20 in the up-down direction. In this state, the protrusions 55 are in contact with the shield portion 61. The ceiling portion 51a and the shield portion 61 are away in the up-down direction with a distance corresponding to the protruding height of the protrusions 55 in between. The ceiling portion 51a and the shield portion 61 are in contact with each other with the protrusions 55 interposed therebetween and form a space in between where the protrusions 55 are not present.

The pair of side portions 51b cover the pair of side walls 21c of the insulator 20 from both right and left sides. The rear portion 51c covers the rear wall 22 of the insulator 20 from the rear side. The rear portion 51c and the rear wall 22 are greatly away from each other in the front-rear direction. A space is present between the rear portion 51c and the rear wall 22.

In the non-inserted state illustrated in FIG. 6, for example, in the first state, the opening 52 formed in the ceiling portion 51a enables all the mount portions 32a and mount portions 32b of the multiple contacts 30 to be seen through the space from above. The opening 52 is formed in the ceiling portion 51a so as to be located immediately above all the mount portions, including the mount portions 32a and the mount portions 32b, in the ceiling portion 51a. In the first state in which a connection object 70 is not inserted into the insertion portion 23 of the insulator 20, the opening 52 enables the mount portions 32a and the mount portions 32b to be seen from immediately above, on the outer surface side, for example, on the upper surface side of the first metal member 50. The opening 52 is formed in the ceiling portion 51a, extending over all the region where the multiple contacts 30 are located in the arrangement direction of the multiple contacts 30.

The lock portions 54 extend from the ceiling portion 51a to the circuit board CB side. More specifically, the lock portions 54 extend obliquely downward toward the front. The lock portions 54 are stored in the attachment slits 28 of the insulator 20. The lock portions 54 are located in the attachment slits 28 so as to be elastically deformable in the up-down direction.

The second metal member 60 is located on the circuit board CB side of the first metal member 50. In the first state illustrated in FIG. 6, the second metal member 60 is attached to the insulator 20 so as to be slidable rearward in the state in which the upper surface of the shield portion 61 is in contact with the protrusions 55, and the lower surface of the shield portion 61 is in contact with the ceiling wall 21a. In this state, the shield portion 61 closes only the area close to of the front edge portion of the opening 52 and does not overlap the other area of the opening 52, so that the mount portions of the multiple contacts 30 are exposed on the upper side through the opening 52. The folded back portion 64 faces the rear surface of the ceiling wall 21a, being adjacent to or in contact with the rear side of the rear surface of the ceiling wall 21a.

Also in the inserted state illustrated in FIG. 7 in which the connection object 70 is inserted into the insertion portion 23, in other words, in the second state, the upper surface of the shield portion 61 is in contact with the protrusions 55, and the lower surface of the shield portion 61 is in contact with the ceiling wall 21a. However, the second metal member 60 is slid rearward from the position in the first state illustrated in FIG. 6 and is located on the insertion side. In this operation, the shield portion 61 is moved along with the insertion of the connection object 70 into the insertion portion 23 and overlaps the entire opening 52 in the second state. The shield portion 61 closes the opening 52 without a gap so that the multiple contacts 30 are completely hidden through the opening 52 when seen from above. The shield portion 61 overlaps the entire opening 52. The folded back portion 64 faces the rear surface of the ceiling wall 21a, being greatly away on the rear side.

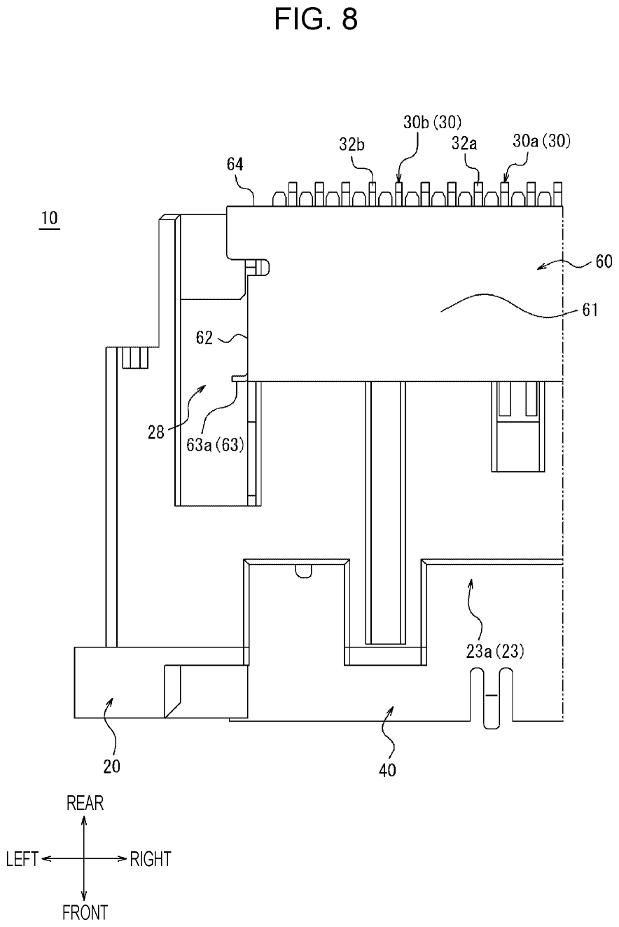

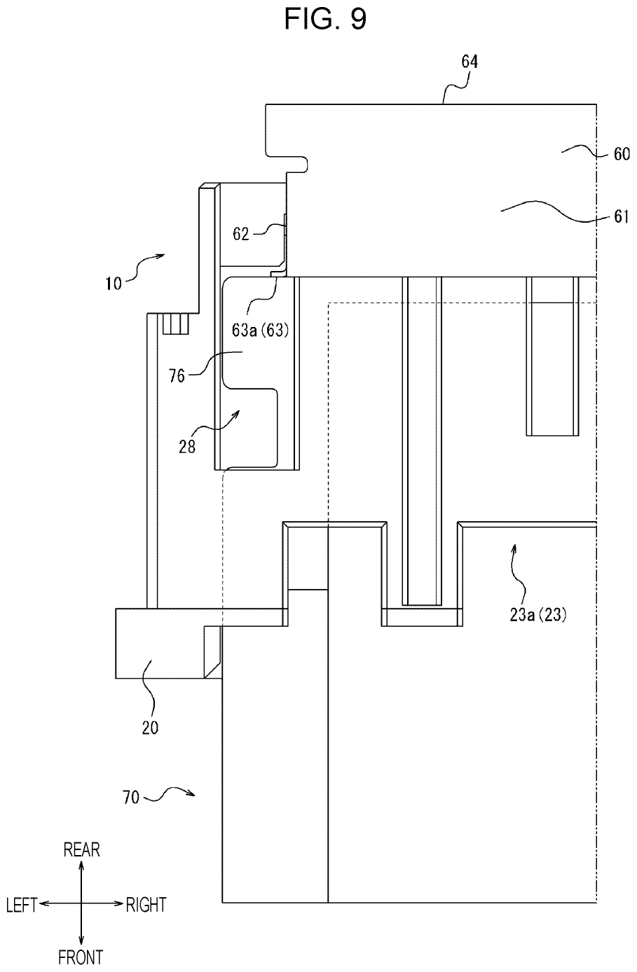

FIG. 8 is an enlarged top view of the dashed-dotted-line rectangular portion VIII in FIG. 6. FIG. 9 is an enlarged top view of the dashed-dotted-line rectangular portion IX in FIG. 7. In both FIGS. 8 and 9, illustration of the first metal member 50 is omitted so that the operation of the second metal member 60 shifted from the first state to the second state can be easily understood.

When the second metal member 60 is attached to the insulator 20, the restriction receiving portions 62 are stored in the attachment slits 28. The restriction receiving portions 62 are located along the right and left inner side surfaces of the attachment slits 28. In this state, the contact portions 63 are located inside the attachment slits 28. The contact surfaces 63a are located inside the attachment slits 28 so as to face the insertion opening 23a of the insertion portion 23.

When the first state illustrated in FIG. 8 is shifted to the second state illustrated in FIG. 9, the contact portions 63 make contact with the connection object 70 due to the insertion of the connection object 70 into the insertion portion 23 and receive pressing forces from the connection object 70 toward the insertion direction of the connection object 70.

More specifically, the contact surfaces 63a make contact with the hold portions 76 of the connection object 70 and receive pressing forces from the hold portions 76 in the insertion direction of the connection object 70. The pressing forces mentioned above slide the second metal member 60 rearward and moves it from the position in the first state to the position in the second state. Thus, the contact between the connection object 70 and the contact portions 63 causes the shield portion 61 to close the entire opening 52 from the circuit board CB side in the second state.

FIG. 10 is a cross-sectional view taken along arrow line X-X in FIG. 7. FIG. 11 is a cross-sectional view taken along arrow line XI-XI in FIG. 7. FIG. 12 is a cross-sectional view taken along arrow line XII-XII in FIG. 7.

When the third metal member 40 is attached to the insulator 20, the engagement portions 45 are engaged with the metal-member attachment slits 26a of the metal-member attachment portion 26. The third metal member 40 is placed so as to be in contact with the upper surface of the bottom wall 21b and thus placed approximately over the entire part of the lower portion of the insertion portion 23. The base portion 41 including the first portion 41a and the second portion 41b is placed on the upper surface of the bottom wall 21b. The first contact portions 42 and the second contact portions 43 extend obliquely upward toward the rear from the upper surface of the bottom wall 21b. The first contact portions 42 and the second contact portions 43 are located in the insertion portion 23 so as to be elastically deformable in the up-down direction.

As illustrated mainly in FIG. 10, in the inserted state in which the connection object 70 is inserted into the insertion portion 23, the second portion 41b of the base portion 41 extends obliquely upward toward the rear from the first portion 41a and is in contact with the first ground portion 73. The position of the contact between the second portion 41b and the connection object 70 is located on the opposite side of the positions of the contact between the first and second contact portions 42 and 43 and the connection object 70 to the distal end of the connection object 70. The position of the contact in the up-down direction between the second portion 41b and the connection object 70 is on the same side of the connection object 70 as the positions of the contact between the first and second contact portions 42 and 43 and the connection object 70.

As illustrated mainly in FIG. 11, the first contact portions 42 extend from the base portion 41 toward the distal end of the connection object 70, and the upper surfaces of the first contact portions 42 are in contact with the second connection lines 72b. The lower surfaces of the first contact portions 42 are in contact with the elastic contact portions 33b of the second contacts 30b. The second contact portions 43 are located on the side of the first contact portions 42 opposite to the distal end of the connection object 70 and are in contact with the first ground portion 73. The first contact portions 42 and the second contact portions 43 are elastically deformed downward in the insertion portion 23 and are in contact with the connection object 70.

The first contact portions 42 and the second contact portions 43 are located on the same side of the connection object 70 in the up-down direction. The first contact portions 42 are in contact with the portions of the second connection lines 72b adjacent to a boundary portion R between the second connection lines 72b and the first ground portion 73. The second contact portions 43 are in contact with portions of the first ground portion 73 adjacent to the boundary portion R.

As can be seen also from FIG. 4, one first contact portion 42 is in contact with the elastic contact portions 33b of multiple second contacts 30b. For example, one first contact portion 42 is in contact with the elastic contact portions 33b of two second contacts 30b adjacent to each other in the right-left direction. Similarly, one first contact portion 42 is in contact with multiple second connection lines 72b. For example, one first contact portion 42 is in contact with two second connection lines 72b adjacent to each other in the right-left direction.

As illustrated mainly in FIG. 10, each first contact 30a is attached to a portion from the rear wall 22 to the inside of the insertion portion 23 by the engagement portion 31a being engaged with a first-contact attachment slit 24 of the insulator 20. When the engagement portion 31a is attached to the first-contact attachment slit 24, the distal end portion of the elastic contact portion 33a is located in the insertion portion 23 so as to be displaceable in the up-down direction along with an elastic deformation of the elastic contact portion 33a.

In the inserted state in which the connection object 70 is inserted into the insertion portion 23, the elastic contact portions 33a of the first contacts 30a are in contact with the lower sides of the first connection lines 72a. In this state, the elastic contact portions 33a are elastically deformed downward. The distal end portions of the elastic contact portions 33a are elastically displaced downward in the insertion portion 23.

When the first metal member 50 is attached to the insulator 20, the lower ends of the contact portions 53a are located in the insertion portion 23 so as to be displaceable in the up-down direction along with elastic deformations of the contact portions 53a. In the inserted state in which the connection object 70 is inserted into the insertion portion 23, the lower ends of the contact portions 53a make contact with the upper side of the second ground portion 74 of the connection object 70. In this state, the contact portions 53a are elastically deformed upward. The lower ends of the contact portions 53a are elastically displaced upward in the insertion portion 23.

As illustrated mainly in FIG. 11, each second contact 30b is attached to a portion from the rear wall 22 to the inside of the insertion portion 23 by the engagement portion 31b being engaged with a second-contact attachment slit 25 of the insulator 20. When the engagement portion 31b is attached to the second-contact attachment slit 25, the distal end portion of the elastic contact portion 33b is located in the insertion portion 23 so as to be displaceable in the up-down direction along with an elastic deformation of the elastic contact portion 33b.

In the inserted state in which the connection object 70 is inserted into the insertion portion 23, the elastic contact portions 33b of the second contacts 30b are in contact with the lower sides of the first contact portions 42 which are in contact with the second connection lines 72b. In this state, the elastic contact portions 33b are elastically deformed downward.

The distal end portions of the elastic contact portions 33b are elasticity displaced downward in the insertion portion 23.

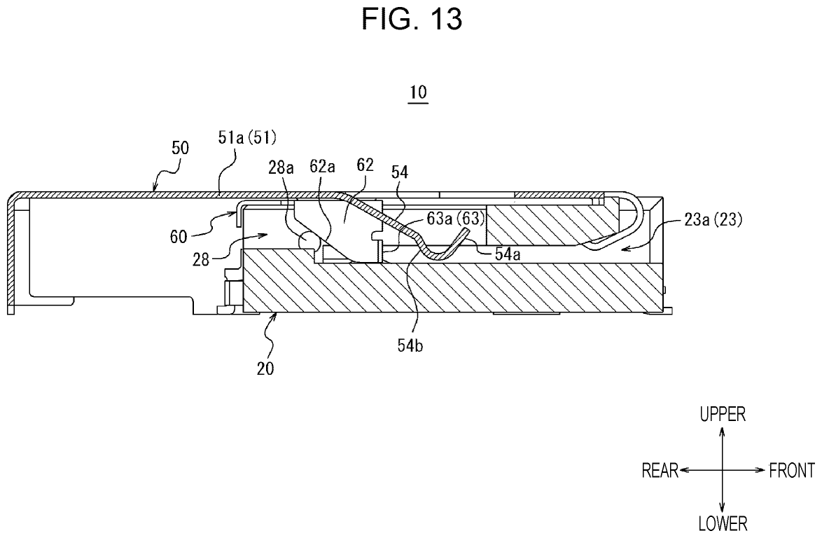

FIG. 13 is a cross-sectional view taken along arrow line XIII-XIII in FIG. 6.

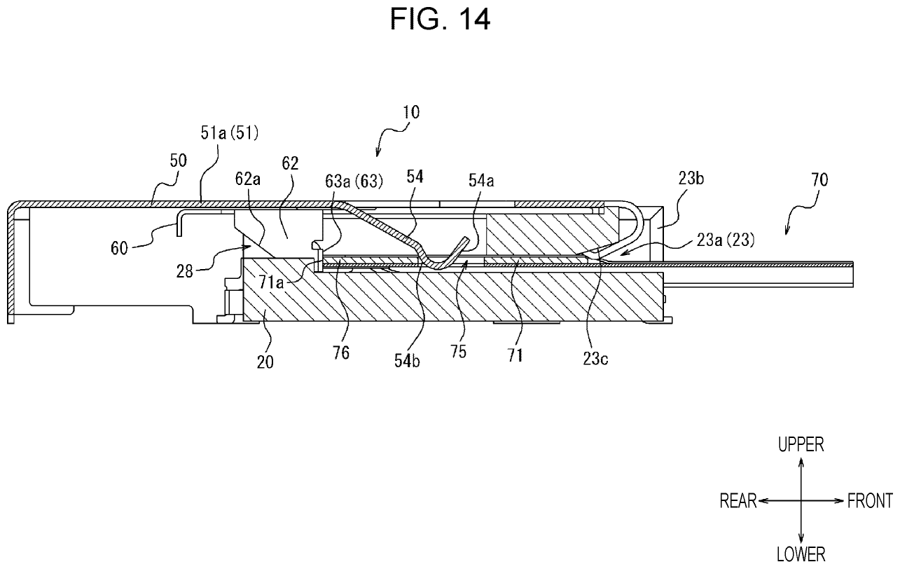

Illustration of the connection object 70 is omitted in FIG. 13. FIG. 14 is a cross-sectional view taken along arrow line XIV-XIV in FIG. 7.

When the first metal member 50 is attached to the insulator 20, the lower ends of the lock portions 54 are located in the insertion portion 23 so as to be displaceable in the up-down direction along with elastic deformations of the lock portions 54. In the non-inserted state in which the connection object 70 is not inserted into the insertion portion 23, the first contact portions 54a of the lock portions 54 are located in the insertion portion 23 so as to face the insertion opening 23a. The second contact portions 54b of the lock portions 54 are located in the insertion portion 23 so as to face the side opposite to the insertion opening 23a.

When the second metal member 60 is attached to the insulator 20, the restriction portions 28a of the attachment slits 28 in the non-inserted state are in contact with or adjacent to the second metal member 60, on the insertion side of the connection object 70. For example, in the state in which both the restriction portions 28a and the restriction receiving portions 62 of the second metal member 60 are located in the attachment slits 28, the restriction portions 28a are in contact with the slope portions 62a of the restriction receiving portions 62, on the insertion side of the connection object 70. This enables the restriction portions 28a to restrict the movement of the second metal member 60 in the insertion direction of the connection object 70 in the non-inserted state.

The contact portions 63 are located in the insertion portion 23. The contact surfaces 63a are located in the insertion portion 23 so as to face the insertion opening 23a. The restriction receiving portions 62 including the contact portions 63 and the restriction portions 28a are located on the insertion side relative to the lock portions 54. In the insertion portion 23, the contact surfaces 63a directly face the second contact portions 54b of the lock portions 54.

The connection object 70 is inserted into the insertion portion 23 of the insulator 20 in the state in which the connector 10 is as illustrated in FIG. 13. When the connection object 70 is inserted into the insertion portion 23 of the connector 10, the distal end portion of the connection object 70 including the reinforcement portion 71 is guided by the first inclined surfaces 23b and the second inclined surfaces 23c of the insulator 20 and enters the insertion portion 23. In this operation, even if the position of the connection object 70 being inserted is slightly shifted from the insertion portion 23 in the right-left direction, the introduction portion 77 of the connection object 70 will slide on the first inclined surface 23b of the insulator 20, and the connection object 70 will be guided into the insertion portion 23. Similarly, even if the position of the connection object 70 being inserted is slightly shifted from the insertion portion 23 in the up-down direction, the distal end portion of the connection object 70 will slide on the second inclined surface 23c of the insulator 20, and the connection object 70 will be guided into the insertion portion 23.

When the connection object 70 further moves into the insertion portion 23, the hold portions 76 of the connection object 70 come into contact with the lock portions 54 of the first metal member 50. In this state, the contact between the lock portions 54 and the hold portions 76 of the connection object 70 with the first contact portions 54a on the pull-out side of the lock portions 54 interposed therebetween generates resistance forces that elastically deform the lock portions 54 upward. Thus, the lock portions 54 are elastically deformed upward by the resistance forces.

When the connection object 70 moves further into the insertion portion 23 with the hold portions 76 in contact with the lock portions 54, the lock portions 54 climb onto the upper surfaces of the hold portions 76 once while pressing the hold portions 76 downward in the up-down direction due to the restoring forces against the elastic deformation of the lock portions 54. Along with the rearward movement of the connection object 70, the hold portions 76 slide relative to the lower ends of the lock portions 54.

When the connection object 70 moves further rearward, the hold portions 76 come into contact with the contact portions 63 of the second metal member 60. Due to the surface contact between the portions of the distal end surface 71a corresponding to the rear surfaces of the hold portions 76 and the contact surfaces 63a of the contact portions 63, the contact portions 63 receive pressing forces in the insertion direction of the connection object 70, from the connection object 70.

If the pressing forces are larger than the resistance forces that the restriction receiving portions 62 receive from the restriction portions 28a due to the contact between the slope portions 62a and the restriction portions 28a, the restriction receiving portions 62 climb onto the restriction portions 28a and start moving rearward. When the restriction receiving portions 62 climb onto the restriction portions 28a, the movement of the second metal member 60 in the insertion direction is no longer restricted by the restriction portions 28a. With this, the pressing forces from the hold portions 76 due to the insertion of the connection object 70 cause the second metal member 60 to slide rearward. The second metal member 60 moves from the position in the first state illustrated in FIG. 13 to the position in the second state illustrated in FIG. 14.

As illustrated in FIG. 14, in the inserted state, the hold portions 76 have passed by the lock portions 54 and are stored in the insertion portion 23. As also illustrated in FIG. 10, the distal end surface 71a of the connection object 70 comes into contact with the inner surface 23d of the insertion portion 23 of the insulator 20. In this state, the lock portions 54 are no longer in contact with the hold portions 76 in the up-down direction, and the lock portions 54 automatically return to the positions before the connection object 70 is inserted due to the restoring forces of the lock portions 54.

In the inserted state described above, the lock portions 54 are engaged with the lock receiving portions 75 of the connection object 70. The second contact portions 54b of the lock portions 54 face the pull-out sides of the hold portions 76. The second contact portions 54b of the lock portions 54 face the front surfaces of the hold portions 76 from the front side, being adjacent to the front surfaces of the hold portions 76. With this configuration, the first metal member 50 holds the connection object 70 inserted into the insertion portion 23 so that the connection object 70 will not come out. In this state, even if an unintended force different from a force to pull out and weaker than a force to pull out is exerted on the connection object 70 in the pull-out direction, the hold portions 76 of the connection object 70 will come into contact with the second contact portions 54b of the lock portions 54, and the movement of the connection object 70 in the pull-out direction will be restricted. This reduces unintended pulling out of the connection object 70, and the connection object 70 is effectively held not to come out.

As described above, the connector 10 does not require an additional operation by an assembly device or an assembly operator, and only a single action of inserting the connection object 70 into the insertion portion 23 enables the connection object 70 to be held in the inserted state and not to come out. Similarly, the connector 10 does not require an additional operation by an assembly device or an assembly operator, and only a single action of pulling the connection object 70 out of the insertion portion 23 enables the connection object 70 to be pulled out.

To pull the connection object 70 out of the connector 10, an assembly device or an assembly operator moves the connection object 70 to the pull-out side. When the connection object 70 moves forward, the hold portions 76 come into contact with the second contact portions 54b of the lock portions 54. In this state, the contact between the lock portions 54 and the hold portions 76 with the second contact portions 54b of the lock portions 54 on the insertion side interposed therebetween generates resistance forces that deform the lock portions 54 elastically upward. Thus, the lock portions 54 are elastically deformed upward by the resistance forces.

When the connection object 70 moves toward the outside of the insertion portion 23 with the hold portions 76 in contact with the lock portions 54, the lock portions 54 climb onto the upper surfaces of the hold portions 76 once while pressing the hold portions 76 downward in the up-down direction due to the restoring forces against the elastic deformation of the lock portions 54. Along with the forward movement of the connection object 70, the hold portions 76 slide relative to the lower ends of the lock portions 54.

When the connection object 70 moves further forward, the hold portions 76 pass by the lock portions 54. In this state, the lock portions 54 are no longer in contact with the hold portions 76 in the up-down direction, and the lock portions 54 automatically return to the positions before the connection object 70 is inserted due to the restoring forces of the lock portions 54. Thus, the connection object 70 is completely pulled out of the connector 10.

The connector 10 does not include a component such as a bias member for returning the second metal member 60 from the position in the second state illustrated in FIG. 14 to the position in the first state illustrated in FIG. 13. Hence, when the connector 10 is completely pulled out of the connection object 70 and placed in the third state, the second metal member 60 remains at the position in the second state illustrated in FIG. 14. In addition, in the course of the insertion of the connection object 70, when the restriction receiving portions 62 of a metal material climb onto the restriction portions 28a of a resin material, the circular protrusions of the restriction portions 28a can be shaved in some cases.

In an embodiment, the connector 10 allows the multiple contacts 30 to be seen through the opening 52 in the first state in which a connection object 70 has never been inserted into the insertion portion 23. In addition, when a connection object 70 is inserted into the insertion portion 23 once, and the connector 10 is shifted to the second state, the second metal member 60 always overlaps the opening 52.

The following describes advantageous effects of the connector 10 with attention focused mainly on the connector 10, and the same or similar description can be applied to an electronic device including the connector 10.

In an embodiment as described above, the connector 10 has a higher workability and a higher noise shielding effect. Since the connector 10 allows the mount portions of the multiple contacts 30 to be seen through the opening 52 of the first metal member 50 in the non-inserted state, quality checks of the mounting states of all of the mount portions 32a and the mount portions 32b onto the circuit board CB are easy. An assembly device or an assembly operator can easily check the mounting states of the mount portions onto the circuit board CB for each of the multiple contacts 30 through the opening 52.

In the connector 10, since the shield portion 61 of the second metal member 60 overlaps the opening 52 in the inserted state along with the insertion of the connection object 70 into the insertion portion 23, an additional operation of opening/closing a cover member is not necessary unlike the conventional technique disclosed in Patent Literature 1. The connector 10 does not require an additional operation by an assembly device or an assembly operator, and only a single action of inserting the connection object 70 into the insertion portion 23 enables the shield portion 61 to shield the opening 52 in the inserted state. This reduces the workload related to the connector 10, and accordingly the workability is improved. For example, it reduces the workload that occurs between when the connection state of the connector 10 onto the circuit board CB is checked after the connector 10 is mounted and when a noise shielding effect is given, and this improves the workability of the connector 10.

In addition to the reduction in the workload described above, the connector 10 has an advantageous effect that operation of the second metal member 60 is easy even when the connector 10 is downsized. The connector 10 does not require an opening/closing operation of a cover member unlike the conventional technique disclosed in Patent Literature 1, and only a single action of inserting the connection object 70 into the insertion portion 23 enables the second metal member 60 to slide. Hence, operation of the second metal member 60 is easy, and this improves the workability of the connector 10.

In the connector 10, since the shield portion 61 of the second metal member 60 overlaps the opening 52 of the first metal member 50 in the inserted state, this improves the noise shielding effect. For example, it effectively reduces external electromagnetic wave noises entering the multiple contacts 30 and emission of electromagnetic wave noises from the multiple contacts 30 to the outside. Thus, for example, the connector 10 provides favorable transmission characteristics for radio-frequency signals also for high-speed transmission.

Along with the insertion of the connection object 70 into the insertion portion 23, the contact portions 63 of the second metal member 60 make contact with the connection object 70 and receive pressing forces in the insertion direction of the connection object 70. In the connector 10, direct contact between the second metal member 60 and the connection object 70 along with the insertion of the connection object 70 enables the shield portion 61 to reliably overlap the opening 52 in the inserted state. Although the movement of the second metal member 60 toward the insertion side is restricted by the restriction portions 28a in the non-inserted state, the second metal member 60 receives strong pressing forces due to direct contact with the connection object 70 along with the insertion of the connection object 70 and moves to the position in the inserted state illustrated in FIG. 14.

Since the shield portion 61 closes the opening 52 from the circuit board CB side, the first metal member 50 can be the outermost portion of the connector 10. If the second metal member 60 is located on the outer side, for example, the upper side, of the first metal member 50, part of the first metal member 50 needs to be cut out to connect the contact portions 63 located inside the connector 10 and the shield portion 61 located in the outermost portion of the connector 10. However, in an embodiment, the connector 10 does not cause such a problem. Similarly, if the second metal member 60 is located on the outer side, for example, the upper side, of the first metal member 50, there is a possibility that when a foreign object or another component or the like in the electronic device is present in the region of the first metal member 50 where the second metal member 60 is movable, the second metal member 60 can move and be caught by the foreign object, the component, or the like. This would reduce the workability and the reliability. However, the connector 10 according to an embodiment will not cause such a problem.

In the connector 10, since the restriction portions 28a of the insulator 20 restrict the movement of the second metal member 60 in the insertion direction in the non-inserted state, unintended movement of the second metal member 60 toward the insertion side without the insertion of the connection object 70 can be reduced. Hence, for example, the state of the connector 10 can be accurately distinguished between when the state of connection to the circuit board CB is checked after the connector 10 is mounted and when a noise shielding effect is given. This improves accuracy in the work related to the connector 10, which improves its workability.

In the connector 10, since the restriction portions 28a are in contact with or adjacent to the second metal member 60, on the insertion side of the connection object 70 in the non-inserted state, the movement of the second metal member 60 toward the insertion side can be restricted more strongly by the insulator 20. Hence, for example, the state of the connector 10 can be distinguished more accurately between when the state of connection to the circuit board CB is checked after the connector 10 is mounted and when a noise shielding effect is given. This further improves accuracy in the work related to the connector 10, which further improves its workability.

In the connector 10, since the first metal member 50 includes the protrusions 55 in contact with the shield portion 61 of the second metal member 60, the sliding resistance when the second metal member 60 slides relative to the first metal member 50 along with the insertion of the connection object 70 can be low. Hence, in the connector 10, the second metal member 60 can slide more smoothly relative to the first metal member 50 along with the insertion of the connection object 70. This improves the workability of the connector 10.

Since the first metal member 50 includes the protrusions 55 in contact with the shield portion 61 of the second metal member 60, the first metal member 50 and the second metal member 60 can be electrically connected to each other. This enables the shielding effect, in other words, noise shielding effect, of the first metal member 50 to be extended to the second metal member 60. The first metal member 50 and the second metal member 60 function as one shield member. This improves the noise shielding effect.

In addition, the first metal member 50 in contact with the second metal member 60 and with the protrusions 55 interposed therebetween is electrically connected to the second ground portion 74 of the connection object 70 with the contact portions 53a interposed therebetween and is electrically connected to the pads on the circuit board CB with the first mount portions 56b and the second mount portions 57b interposed therebetween. This enables the first metal member 50 and the second metal member 60 to function stably as one ground. Hence, the first metal member 50 and the second metal member 60 provide a stable noise shielding effect.

In the connector 10, since the protrusions 55 have straight line shapes parallel to the insertion direction of the connection object 70, the sliding resistance when the second metal member 60 slides relative to the first metal member 50 along with the insertion of the connection object 70 can be lower. Hence, in the connector 10, the second metal member 60 can slide more smoothly relative to the first metal member 50 along with the insertion of the connection object 70. This further improves the workability of the connector 10.

In the connector 10, since the first metal member 50 includes the lock portions 54 configured to be engaged with the lock receiving portions 75 of the connection object 70 in the inserted state, the connection object 70 inserted into the insertion portion 23 can be held so as not to come out. In this state, even if an unintended force different from a force to pull out and weaker than a force to pull out is exerted on the connection object 70 in the pull-out direction, the hold portions 76 of the connection object 70 will come into contact with the second contact portions 54b of the lock portions 54, and the movement of the connection object 70 in the pull-out direction will be restricted. This reduces unintended pulling out of the connection object 70, and the connection object 70 is effectively held not to come out.

Since the first contact portions 42 of the third metal member 40 are in contact with the elastic contact portions 33b of the second contacts 30b, the third metal member 40 and the second contacts 30b can be electrically connected. In this configuration, the second contacts 30b are electrically connected to pads of the circuit board CB with the mount portions 32b interposed therebetween. The third metal member 40 is electrically connected to the connection lines 72 of the connection object 70 with the first contact portions 42 interposed therebetween, electrically connected to the first ground portion 73 of the connection object 70 with the second contact portions 43 interposed therebetween, and electrically connected to pads on the circuit board CB with the mount portions 44 interposed therebetween. Thus, the third metal member 40, the second contacts 30b, and the connection lines 72 associated with the second contacts 30b function stably as one ground.

In the connector 10, since the first metal member 50 includes the outer peripheral portion 51 including the outer periphery on the front, the right and left, and the rear sides, the outer peripheral portion 51 of the first metal member 50 can provide a shield function of the connector 10. In the connector 10, since the outer peripheral portion 51 covers the components of the connector 10 from the outer side, it further improves the foregoing noise shielding effect.

In the connector 10, since the first metal member 50 has the folded portions 57a, the outer peripheral portion 51 of the first metal member 50 does not have a gap at its corner portions. This further improves the shield function of the connector 10 and further improves the foregoing noise shielding effect.

Each rear corner portion of the first metal member 50 has a two-layer structure in the right-left direction including the portion of a folded portion 57a extending in the front-rear direction and a rear end portion of a side portion 51b. This further improves the shield function of the connector 10 and further improves the foregoing noise shielding effect.

In the connector 10, since the second metal member 60 includes the folded back portion 64, the movement of the second metal member 60 in the pull-out direction can be restricted in the non-inserted state. For example, even if the second metal member 60 seeks to move in the pull-out direction in the non-inserted state, the folded back portion 64 will come into contact with the rear surface of the ceiling wall 21a so that the second metal member 60 cannot move any further in the pull-out direction.

Those skilled in the art will clearly understand that the present disclosure can be implemented in other appropriate embodiments other than the aforementioned embodiment without departing from the spirit or the essential features. Hence, the above description is exemplary and does not limit the present disclosure. The scope of the disclosure is defined not by the above description but by the appended claims. Of various changes, several changes within the scope of the equivalents of the claims are included in the scope of the disclosure.

For example, the shape, size, position, orientation of each aforementioned component, the number of components, and the like are not limited to the above description and the illustration in the drawings. The shape, size, position, orientation of each component, the number of components, and the like may be configured in any way that enables the function of the component.

The aforementioned method of assembling the connector 10 is not limited to the above description. The connector 10 may be assembled by any method that enables each component to function properly. For example, at least one item out of the first contacts 30a, the second contacts 30b, the third metal member 40, and the first metal member 50 may be integrated into the insulator 20 by insert molding.

Although in the description of the aforementioned embodiment, the second metal member 60 includes the contact portions 63 which make contact with the connection object 70 and receive pressing forces in the insertion direction of the connection object 70 when the connection object 70 is inserted into the insertion portion 23, the present disclosure is not limited to this configuration. The present disclosure is not limited to such direct contact between the second metal member 60 and the connection object 70 along with the insertion of the connection object 70, and indirect contact between the second metal member 60 and the connection object 70 along with the insertion of the connection object 70 may cause the shield portion 61 to close the opening 52 in the inserted state. For example, another additional member may be provided between the second metal member 60 and the connection object 70, and the connection object 70 may come into indirect contact with the second metal member 60.

Although in the description of the aforementioned embodiment, the second metal member 60 is located on the circuit board CB side of the first metal member 50, the present disclosure is not limited to this configuration. The second metal member 60 may be located on the side of the first metal member 50 opposite to the circuit board CB. In that case, direct or indirect contact between the connection object 70 and the second metal member 60 may cause the shield portion 61 to close the opening 52 from the side of the first metal member 50 opposite to the circuit board CB.

Although in the description of the aforementioned embodiment, the insulator 20 includes the restriction portions 28a which restrict the movement of the second metal member 60 in the insertion direction in the non-inserted state, the present disclosure is not limited to this configuration. The connector 10 may have a configuration without portions corresponding to the restriction portions 28a described above.

Although in the description of the aforementioned embodiment, the restriction portions 28a are circular protrusions formed on side surfaces of the attachment slits 28, the present disclosure is not limited to this configuration. The restriction portions 28a may have any shapes and arrangement that enable restriction of the movement of the second metal member 60 in the insertion direction.

Although in the description of the aforementioned embodiment, the restriction portions 28a in the non-inserted state are in contact with or adjacent to the second metal member 60, on the insertion side of the connection object 70, the present disclosure is not limited to this configuration. The restriction portions 28a in the non-inserted state may be in contact with or adjacent to the second metal member 60 on any side as long as the restriction portions 28a can restrict the movement of the second metal member 60 in the insertion direction. For example, the restriction portions 28a may be plate springs located in the attachment slits 28 of the insulator 20 and configured to press the outer sides in the right-left direction of the restriction receiving portions 62 of the second metal member 60.

Although in the description of the aforementioned embodiment, when the connection object 70 is completely pulled out of the connector 10, and the connector 10 is placed in the third state, the second metal member 60 remains at the position in the second state illustrated in FIG. 14, the present disclosure is not limited to this configuration. The connector 10 may have an additional bias member that biases the second metal member 60 in the pull-out direction when the connector 10 is placed in the third state so that the second metal member 60 can return from the position in the second state illustrated in FIG. 14 to the position in the first state illustrated in FIG. 13. With such a component, when the connection object 70 is completely pulled out of the connector 10, and the pressing forces toward the insertion side are no longer exerted on the second metal member 60, the second metal member 60 can return to the position in the first state illustrated in FIG. 13 by a biasing force of the bias member.

Although in the description of the aforementioned embodiment, in the course of the insertion of the connection object 70, when the restriction receiving portions 62 of a metal material climb onto the restriction portions 28a of a resin material, the circular protrusions of the restriction portions 28a can be shaved in some cases, the present disclosure is not limited to this configuration. The restriction portions 28a may be elastically deformable members on side surfaces of the attachment slits 28. In that case, when the restriction receiving portions 62 climb onto the restriction portions 28a in the course of insertion, the restriction portions 28a will be elastically deformed inward in the right-left direction. For example, when the second metal member 60 is returned to the position in the first state illustrated in FIG. 13 by the foregoing bias member, the restriction portions 28a return from the states of being elastically deformed inward in the right-left direction to free states of not being elastically deformed. The function of the restriction portions 28a that restricts the movement of the second metal member 60 in the insertion direction in the non-inserted state can be maintained even if the connection object 70 is repeatedly inserted into and pulled out of the insertion portion 23.

In addition, the surfaces of the slope portions 62a of the restriction receiving portions 62 that make contact with the restriction portions 28a when the restriction receiving portions 62 climb over the restriction portions 28a may have rounded shapes. This configuration makes it less likely that the restriction portions 28a which are circular protrusions as an example are shaved when the restriction receiving portions 62 of a metal material climb over the restriction portions 28a of a resin material. Hence, the function of the restriction portions 28a that restricts the movement of the second metal member 60 in the insertion direction in the non-inserted state can be maintained even if the connection object 70 is repeatedly inserted into and pulled out of the insertion portion 23.

Although in the description of the aforementioned embodiment, the connector 10 allows the multiple contacts 30 to be seen through the opening 52 in the first state in which a connection object 70 has never been inserted into the insertion portion 23, the present disclosure is not limited to this configuration. The connector 10 may allow the multiple contacts 30 to be seen through the opening 52 repeatedly in the third state after a connection object 70 is repeatedly inserted into and pulled out of the insertion portion 23. In the connector 10, the foregoing bias member may enable repeated sliding operations of the shield portion 61 in the insertion-pull-out direction relative to the opening 52, corresponding to repeated operations of inserting and pulling the connection object 70 into and out of the insertion portion 23.

Although in the description of the aforementioned embodiment, since the second metal member 60 includes the folded back portion 64 in the connector 10, the movement of the second metal member 60 in the pull-out direction can be restricted in the non-inserted state, the present disclosure is not limited to this configuration. The connector 10 may have a configuration in which the movement of the second metal member 60 in the pull-out direction can be restricted also in the inserted state. This configuration reduces unintended movement of the second metal member 60 in the pull-out direction in the inserted state in the connector 10. This makes it less likely that the shield portion 61 overlapping the opening 52 is unintentionally canceled in the inserted state, and the opening 52 opens. Thus, the shield portion 61 of the second metal member 60 can overlap the opening 52 in the inserted state.

Although in the description of the aforementioned embodiment, the first metal member 50 includes the protrusions 55 configured to be in contact with the second metal member 60, the present disclosure is not limited to this configuration. In addition to or instead of the first metal member 50, the second metal member 60 may have a protrusion configured to be in contact with the first metal member 50.

Although in the description of the aforementioned embodiment, the protrusions 55 are located on the inner surface of the ceiling portion 51a on the circuit board CB side and have straight line shapes parallel to the insertion direction of the connection object 70, the present disclosure is not limited to this configuration. The protrusions 55 may have any shapes, arrangement, orientation, and number, as long as they can reduce the sliding resistance caused when the second metal member 60 slides relative to the first metal member 50 along with the insertion of the connection object 70.

Although in the description of the aforementioned embodiment, each of the pair of lock portions 54 of the first metal member 50 extends from the ceiling portion 51a to the circuit board CB side and has the shape and size illustrated in FIG. 13, the present disclosure is not limited to this configuration. The lock portions 54 may have any shapes, sizes, arrangement, orientation, and number, as long as they can provide a function of holding the connection object 70 so that the connection object 70 cannot come out.

Although in the description of the aforementioned embodiment, the first metal member 50 includes the lock portions 54 configured to be engaged with the lock receiving portions 75 of the connection object 70 in the inserted state, the present disclosure is not limited to this configuration. The connector 10 may have a configuration without portions corresponding the lock portions 54 described above.

Although in the aforementioned embodiment, portions of the ceiling portion 51a of the first metal member 50 where the lock portion 54 are formed are cut out, the present disclosure is not limited to this configuration. Such cut-out portions may be covered to further improve the noise shielding effect.

Although in the description of the aforementioned embodiment, the opening 52 is formed in the ceiling portion 51a such that the opening 52 is located in the ceiling portion 51a so as to be immediately above all the mount portions including the mount portions 32a and the mount portions 32b, the present disclosure is not limited to this configuration. The opening 52 may have any shape, size, arrangement, orientation, and number as long as at least part of the mount portions including the mount portions 32a and the mount portions 32b can be seen through the opening 52 in the non-inserted state. For example, the opening 52 may be formed in the ceiling portion 51a such that the opening 52 is located in the ceiling portion 51a so as to be obliquely above at least part of the mount portions including the mount portions 32a and the mount portions 32b. In that case, the opening 52 allows at least part of the mount portions to be seen from obliquely above, from the upper surface of the first metal member 50 in the non-inserted state.

Although in the description of the aforementioned embodiment, the shield portion 61 moves along with the insertion of the connection object 70 into the insertion portion 23 and overlaps the entire opening 52 in the inserted state, the present disclosure is not limited to this configuration. The connector 10 may have a configuration in which the shield portion 61 overlaps only part of the opening 52 in the inserted state as long as the configuration provides a specified noise shielding effect.

Although in the description of the aforementioned embodiment, the second metal member 60 is attached to the insulator 20, the present disclosure is not limited to this configuration. The second metal member 60 may be attached to the first metal member 50 or may be attached to both the insulator 20 and the first metal member 50.

Although in the description of the aforementioned embodiment, the third metal member 40 has total four sets of a first contact portion 42 and a second contact portion 43, two sets on the left side and two sets on the right side, the present disclosure is not limited to this configuration. The third metal member 40 needs only to include at least one set of a first contact portion 42 and a second contact portion 43, and the arrangement and the number of sets may be of any configuration in the third metal member 40. For example, the third metal member 40 may have only total two sets of a first contact portion 42 and a second contact portion 43, one set on the left side and one set on the right side.

Although in the description of the aforementioned embodiment, a connection object 70 can be inserted into and pulled out of the connector 10, the present disclosure is not limited to this configuration. The connector 10 may be connected to the connection object 70 by a method other than insertion and pulling out.

The connector 10 described above is mounted on electronic devices. Examples of the electronic devices include communication devices such as smartphones. However, the present disclosure is not limited to these. Examples of the electronic devices may include any kind of information devices such as personal computers, copy machines, printers, fax machines, and multifunction printers. Examples of the electronic devices may include any kind of car-mounted devices such as cameras, radars, drive recorders, and engine control units. Examples of the electronic devices may include any kind of car-mounted devices used in car-mounted systems, such as car navigation systems, advanced driver assistance systems, and security systems. In addition, examples of the electronic devices may include any kind of industrial devices. Examples of the electronic devices may include any kind of audio video devices such as liquid crystal television sets, recorders, cameras, and headphones.

Such electronic devices will have a high workability and a high noise shielding effect.

The following concepts can be extracted from the present disclosure.

### 1

A connector including:
an insulator including an insertion portion into which a connection object is inserted;
multiple contacts attached to the insulator, each contact including a mount portion configured to be mounted on a circuit board;
a first metal member attached to the insulator; and
a second metal member attached to at least one of the insulator or the first metal member, in which
the first metal member includes an opening that enables the mount portions to be seen from an outer surface of the first metal member in a non-inserted state in which the connection object is not inserted into the insertion portion, and
the second metal member includes a shield portion configured to move along with insertion of the connection object into the insertion portion and to overlap the opening in an inserted state in which the connection object is inserted into the insertion portion.

### 2

The connector according to (1), in which
the second metal member includes a contact portion configured to, when the connection object is inserted into the insertion portion, make contact with the connection object and receive a pressing force in an insertion direction of the connection object, from the connection object.

### 3

The connector according to (1) or (2), in which
the second metal member is configured to close the opening of the first metal member from the circuit board side, the first metal member covering the insulator from a side opposite to the circuit board.

### 4

The connector according to (2), in which
the insulator includes a restriction portion configured to restrict movement of the second metal member in the insertion direction in the non-inserted state. (

### 5

The connector according to any one of (1) to (4), in which
at least one of the first metal member or the second metal member includes a protrusion in contact with the other.

### 6

The connector according to (5), in which
the first metal member includes a ceiling portion covering the insulator from a side opposite to the circuit board and including the opening, and
the protrusion is located on an inner surface of the ceiling portion on the circuit board side and has a straight line shape parallel to an insertion direction of the connection object.

### 7

The connector according to (6), in which
the first metal member includes an elastically deformable lock portion extending from the ceiling portion to the circuit board side and configured to be engaged with a lock receiving portion of the connection object in the inserted state.

### 8

An electronic device including
the connector according to any one of (1) to (7).

### REFERENCE SIGNS

10 connector
20 insulator
21 outer peripheral wall
21a ceiling wall
21b bottom wall
21c side wall
22 rear wall
23 insertion portion
23a insertion opening
23b first inclined surface
23c second inclined surface
23d inner surface
24 first-contact attachment slit
25 second-contact attachment slit
26 metal-member attachment portion
26a metal-member attachment slit
26b first cut-out portion
27 attachment portion
27a slit
27b first through hole
27c second cut-out portion
27d second through hole
28 attachment slit
28a restriction portion
30 contact
30a first contact
31a engagement portion
32a mount portion
33a elastic contact portion
30b second contact
31b engagement portion
32b mount portion
33b elastic contact portion
40 third metal member
41 base portion
41a first portion
41b second portion
42 first contact portion
43 second contact portion
44 mount portion
45 engagement portion
50 first metal member
51 outer peripheral portion
51a ceiling portion
51b side portion
51c rear portion
52 opening
53a contact portion
53b hold portion
54 lock portion
54a first contact portion
54b second contact portion
55 protrusion
56a engagement portion
56b first mount portion
57a folded portion
57b second mount portion
60 second metal member
61 shield portion
62 restriction receiving portion
62a slope portion
63 contact portion
63a contact surface
64 folded back portion
70 connection object
71 reinforcement portion
71a distal end surface
72 connection line
72a first connection line
72b second connection line
73 first ground portion
74 second ground portion
75 lock receiving portion
76 hold portion
77 introduction portion
CB circuit board
R boundary portion

1. A connector comprising:
an insulator comprising an insertion portion into which a connection object is inserted;
multiple contacts attached to the insulator, each contact comprising a mount portion configured to be mounted on a circuit board;
a first metal member attached to the insulator; and
a second metal member attached to at least one of the insulator or the first metal member, wherein
the first metal member comprises an opening that enables the mount portions to be seen from an outer surface of the first metal member in a non-inserted state in which the connection object is not inserted into the insertion portion, and
the second metal member comprises a shield portion configured to move along with insertion of the connection object into the insertion portion and to overlap the opening in an inserted state in which the connection object is inserted into the insertion portion.

2. The connector according to claim 1, wherein
the second metal member comprises a contact portion configured to, when the connection object is inserted into the insertion portion, make contact with the connection object and receive a pressing force in an insertion direction of the connection object, from the connection object.

3. The connector according to claim 1, wherein
the second metal member is configured to close the opening of the first metal member from the circuit board side, the first metal member covering the insulator from a side opposite to the circuit board.

4. The connector according to claim 2, wherein
the insulator comprises a restriction portion configured to restrict movement of the second metal member in the insertion direction in the non-inserted state.

5. The connector according to claim 1, wherein
at least one of the first metal member or the second metal member comprises a protrusion in contact with the other.

6. The connector according to claim 5, wherein
the first metal member comprises a ceiling portion covering the insulator from a side opposite to the circuit board and comprising the opening, and
the protrusion is located on an inner surface of the ceiling portion on the circuit board side and has a straight line shape parallel to an insertion direction of the connection object.

7. The connector according to claim 6, wherein
the first metal member comprises an elastically deformable lock portion extending from the ceiling portion to the circuit board side and configured to be engaged with a lock receiving portion of the connection object in the inserted state.

8. An electronic device comprising
the connector according to claim 1.
